(19) United States
(12) Patent Application Publication
(10) Pub. No.: US 2006/0223571 A1
(43) Pub. Date: Oct. 5, 2006

(54) Cell phone having laser lighting effect

(76) Inventor: Shih-Ming Hsu, Taichung Hsien (TW)

Correspondence Address: NIKOLAI & MERSEREAU, P.A., 900 SECOND AVENUE SOUTH, SUITE 820, MINNEAPOLIS, MN, 55402, US

(21) Appl. No.: 11/325,202

(22) Filed: Jan. 4, 2006

(30) Foreign Application Priority Data
Mar. 30, 2005 (TW) 94204894

(51) Int. Cl. H04M 1/00

(52) U.S. Cl. 455/550.1

(57) ABSTRACT

A cell phone having a laser lighting effect includes a housing, and a laser indicator mounted on the housing to emit a laser light outwardly from the housing to provide a laser lighting effect. The laser indicator includes a laser generator, a shade, a light permeable plate, a switch, and a push button. Thus, the cell phone is provided with a laser generator which emits a laser beam outwardly to provide a laser lighting effect, so that the cell phone has an indicating function available for speech or teach and has a lighting function available for a dark site, thereby enhancing the versatility of the cell phone. In addition, the laser beam from the laser generator presents a pattern, thereby enhancing the aesthetic quality of the cell phone.

### BACKGROUND OF THE INVENTION

1. Field of the Invention

The present invention relates to a cell phone and, more particularly, to a cell phone having a laser lighting effect.

2. Description of the Related Art

A conventional cell phone in accordance with the prior art shown in FIG. 3 comprises a housing 11, and an antenna 12 mounted on the top of the housing 11. However, the antenna 12 of the cell phone only has a single function, thereby decreasing the versatility of the cell phone.

### SUMMARY OF THE INVENTION

In accordance with the present invention, there is provided a cell phone, comprising a housing, and a laser indicator mounted on the housing to emit a laser light outwardly from the housing to provide a laser lighting effect.

The primary objective of the present invention is to provide a cell phone having a laser lighting effect.

Another objective of the present invention is to provide a cell phone that is provided with a laser generator which emits a laser beam outwardly to provide a laser lighting effect, so that the cell phone has an indicating function available for speech or teach and has a lighting function available for a dark or show site, thereby enhancing the versatility of the cell phone.

A further objective of the present invention is to provide a cell phone, wherein the laser beam from the laser generator presents a pattern or the like, thereby enhancing the aesthetic quality of the cell phone.

A further objective of the present invention is to provide a cell phone, wherein the laser indicator functions an antenna of the cell phone at a normal state.

Further benefits and advantages of the present invention will become apparent after a careful reading of the detailed description with appropriate reference to the accompanying drawings.

### BRIEF DESCRIPTION OF THE DRAWINGS

FIG. 1 is a plan view of a cell phone in accordance with the preferred embodiment of the present invention.

FIG. 2 is a partially plan cross-sectional view of the cell phone in accordance with the preferred embodiment of the present invention.

FIG. 3 is a perspective view of a conventional cell phone in accordance with the prior art.

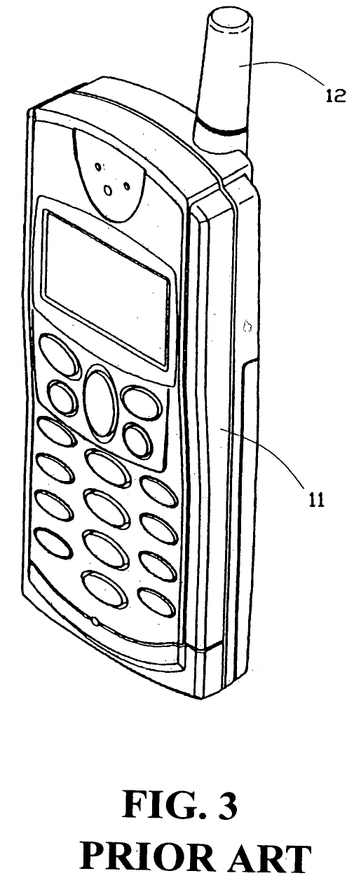

### DETAILED DESCRIPTION OF THE INVENTION

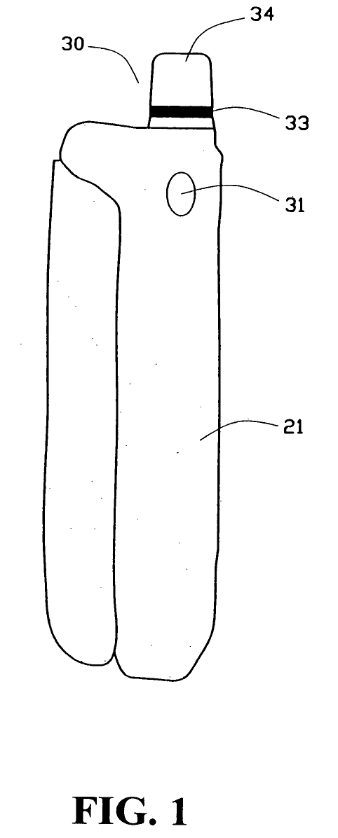

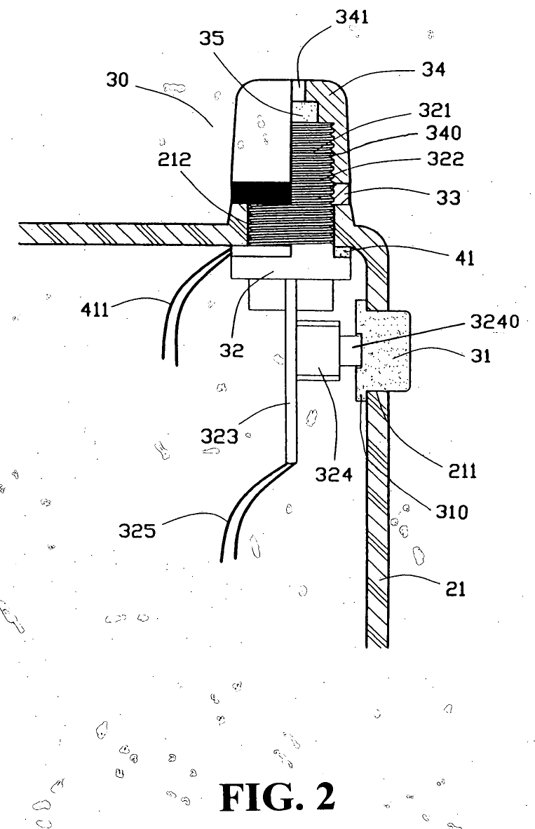

Referring to FIGS. 1 and 2, a cell phone in accordance with the preferred embodiment of the present invention comprises a housing 21, and a laser indicator 30 mounted on the housing 21 to emit a laser light outwardly from the housing 21 to provide a laser lighting effect.

The housing 21 has a top wall formed with a through hole 212 and a side wall formed with a side hole 211.

The laser indicator 30 includes a laser generator 32 mounted in the housing 21 and having a light emitting terminal 321 protruding outwardly from the housing 21 to emit a laser beam outwardly from the housing 21, a shade 34 mounted on the housing 21 and enclosed around the light emitting terminal 321 of the laser generator 32 so that the light emitting terminal 321 of the laser generator 32 is entirely hidden in the shade 34 without being exposed outwardly from the housing 21, a light permeable plate 35 mounted in the shade 34 and located between the light emitting terminal 321 of the laser generator 32 and the shade 34, a switch 324 mounted in the housing 21 and connected to the laser generator 32 to control operation of the laser generator 32, and a push button 31 movably mounted on the housing 21 and rested on the switch 324 to control operation of the switch 324.

The push button 31 of the laser indicator 30 is extended through the side hole 211 of the housing 21 and has a first side rested on a retractable end 3240 of the switch 324 and a second side protruding outwardly from the side hole 211 of the housing 21. The first side of the push button 31 of the laser indicator 30 has a periphery provided with a protruding stop portion 310 rested on an inner wall of the housing 21.

The laser generator 32 of the laser indicator 30 has a side provided with a chip board 323 connected to the switch 324 and connected to electric wires 325. The light emitting terminal 321 of the laser generator 32 of the laser indicator 30 is extended through and protruded outwardly from the through hole 212 of the housing 21. The light emitting terminal 321 of the laser generator 32 of the laser indicator 30 has a reduced diameter and has an outer periphery provided with an outer thread 322.

The laser indicator 30 further includes a locking nut 33 screwed onto the outer thread 322 of the light emitting terminal 321 of the laser generator 32 and rested on the housing 21 to lock the laser generator 32 on the housing 21.

The shade 34 of the laser indicator 30 has an inner periphery provided with an inner thread 340 screwed onto the outer thread 322 of the light emitting terminal 321 of the laser generator 32 and has a closed end wall formed with an aperture 341 aligning with the light permeable plate 35 and the light emitting terminal 321 of the laser generator 32 and an open end wall rested on the locking nut 33.

The light permeable plate 35 of the laser indicator 30 has a face provided with a light permeable pattern.

In operation, when the push button 31 is pressed to push the switch 324, the laser generator 32 is operated by the switch 324 so that the light emitting terminal 321 of the laser generator 32 emits outwardly a laser beam which passes through the light permeable plate 35 and the aperture 341 of the shade 34 and is projected outwardly from the aperture 341 of the shade 34 to provide a laser lighting effect. At this time, the light permeable plate 35 of the laser indicator 30 has a face provided with a light permeable pattern, so that the laser beam from the light emitting terminal 321 of the laser generator 32 presents the light permeable pattern of the light permeable plate 35. When the force applied on the push button 31 is removed, the laser generator 32 stops operating by control of the switch 324 to stop the laser beam.

In the preferred embodiment of the present invention, the cell phone further comprises an antenna conducting plate 41 mounted in the housing 21 and located between the housing 21 and the laser generator 32 of the laser indicator 30, and conducting wires 411 mounted in the housing 21 and connected to the antenna conducting plate 41, so that the laser indicator 30 functions an antenna of the cell phone at a normal state.

Accordingly, the cell phone is provided with a laser generator which emits a laser beam outwardly to provide a laser lighting effect, so that the cell phone has an indicating function available for speech or teach and has a lighting function available for a dark or show site, thereby enhancing the versatility of the cell phone. In addition, the laser beam from the laser generator presents a pattern or the like, thereby enhancing the aesthetic quality of the cell phone. Further, the laser indicator functions an antenna of the cell phone at a normal state.

Although the invention has been explained in relation to its preferred embodiment(s) as mentioned above, it is to be understood that many other possible modifications and variations can be made without departing from the scope of the present invention. It is, therefore, contemplated that the appended claim or claims will cover such modifications and variations that fall within the true scope of the invention.

What is claimed is:

1. A cell phone, comprising:
a housing;
a laser indicator mounted on the housing to emit a laser light outwardly from the housing to provide a laser lighting effect.

2. The cell phone in accordance with claim 1, wherein the laser indicator includes:
a laser generator mounted in the housing and having a light emitting terminal protruding outwardly from the housing to emit a laser beam outwardly from the housing;
a shade mounted on the housing and enclosed around the light emitting terminal of the laser generator;
a light permeable plate located between the light emitting terminal of the laser generator and the shade;
a switch mounted in the housing and connected to the laser generator to control operation of the laser generator;
a push button movably mounted on the housing and rested on the switch to control operation of the switch.

3. The cell phone in accordance with claim 2, wherein the light emitting terminal of the laser generator is entirely hidden in the shade without being exposed outwardly from the housing.

4. The cell phone in accordance with claim 2, wherein the light permeable plate is mounted in the shade.

5. The cell phone in accordance with claim 2, wherein the housing has a side wall formed with a side hole, and the push button of the laser indicator is extended through the side hole of the housing.

6. The cell phone in accordance with claim 5, wherein the push button of the laser indicator has a first side rested on a retractable end of the switch and a second side protruding outwardly from the side hole of the housing.

7. The cell phone in accordance with claim 6, wherein the first side of the push button of the laser indicator has a periphery provided with a protruding stop portion rested on an inner wall of the housing.

8. The cell phone in accordance with claim 2, wherein the laser generator of the laser indicator has a side provided with a chip board connected to the switch and connected to electric wires.

9. The cell phone in accordance with claim 2, wherein the housing has a top wall formed with a through hole, and light emitting terminal of the laser generator of the laser indicator is extended through and protruded outwardly from the through hole of the housing.

10. The cell phone in accordance with claim 2, wherein the light emitting terminal of the laser generator of the laser indicator has a reduced diameter.

11. The cell phone in accordance with claim 2, wherein the light emitting terminal of the laser generator of the laser indicator has an outer periphery provided with an outer thread.

12. The cell phone in accordance with claim 11, wherein the laser indicator further includes a locking nut screwed onto the outer thread of the light emitting terminal of the laser generator and rested on the housing to lock the laser generator on the housing.

13. The cell phone in accordance with claim 12, wherein the shade of the laser indicator has an inner periphery provided with an inner thread screwed onto the outer thread of the light emitting terminal of the laser generator.

14. The cell phone in accordance with claim 2, wherein the shade of the laser indicator has a closed end wall formed with an aperture aligning with the light permeable plate and the light emitting terminal of the laser generator.

15. The cell phone in accordance with claim 12, wherein the shade of the laser indicator has an open end wall rested on the locking nut.

16. The cell phone in accordance with claim 2, wherein the light permeable plate of the laser indicator has a face provided with a light permeable pattern.

17. The cell phone in accordance with claim 12, further comprising an antenna conducting plate mounted in the housing and located between the housing and the laser generator of the laser indicator, and conducting wires mounted in the housing and connected to the antenna conducting plate, so that the laser indicator functions an antenna of the cell phone at a normal state.
